(19) United States
(12) Patent Application Publication
(10) Pub. No.: US 2017/0222530 A1
(43) Pub. Date: Aug. 3, 2017

(54) RESETTABLE DUAL DIAMAGNETIC LINEAR RESONANT ACTUATOR

(71) Applicant: TOPRAY MEMS INC., Hsinchu City (TW)

(72) Inventors: Chin-Sung LIU, Hsinchu City (TW); Hsiao-Ming CHIEN, Hsinchu City (TW)

(73) Assignee: TOPRAY MEMS INC., Hsinchu City (TW)

(21) Appl. No.: 15/159,224

(22) Filed: May 19, 2016

(30) Foreign Application Priority Data
Jan. 29, 2016 (TW) 105201485

(51) Int. Cl. H02K 33/02

(52) U.S. Cl. CPC H02K 33/02

(57) ABSTRACT

A resettable dual diamagnetic linear resonant actuator is disclosed, comprising: a first and a second magnetic induction element, a magnet set and a coil. The magnet set comprises four magnets. The N pole of first magnet, the N pole of second magnet, the S pole of third magnet and the S pole of fourth magnet press respectively against the first, second, third and fourth side of the first magnet induction element. The coil surrounds the first magnetic induction element, the third and fourth magnets, and maintains a distance from the first end and the second end of the first magnetic induction element, and from the N pole of the third and fourth magnets. As such, the movable part formed by the first and second magnetic induction elements and the magnet set can return to original position by magnetic restoration force after cutting electricity off from the coil.

### CROSS-REFERENCE TO RELATED APPLICATION

The present application is based on, and claims priority form, Taiwan Patent Application No. 105201485, filed Jan. 29, 2016, the disclosure of which is hereby incorporated by reference herein in its entirety.

### TECHNICAL FIELD

The technical field generally relates to a linear resonant actuator, and in particular, to a resettable dual diamagnetic linear resonant actuator based on resonance generated by electromagnetic effect.

### BACKGROUND

The resonance of portable electronic devices, such as, mobile phones or tablet PCs, is generated by a resonant device inside the portable electronic device. The earlier resonant device often relies on eccentric rotating mass (ERM) vibration motor to provide resonance.

Recently, a trend is forming by replacing the ERM vibration motor with a linear resonant actuator to serve as the resonant device. The reason is that the linear resonant actuator utilizes the Lorentz force generated by electromagnetic effect to drive simple harmonic motion to generate resonance, which is fast in response and low in power-consumption.

However, the known linear resonant actuator has the disadvantage that once the electricity is cut off from the coil, the Lorentz force is lost and the movable part will stop immediately and unable to return to original position.

Hence, it is desirable to provide a linear resonant actuator, wherein the movable part is able to return to original position after the electricity cut off from the coil.

### SUMMARY

The primary object of the present invention is to provide a resettable dual diamagnetic linear resonant actuator, able to utilize magnetic restoration force to return the movable part to original position after the electricity cut off from the coil.

To achieve the aforementioned objects, the present invention provides a resettable dual diamagnetic linear resonant actuator, comprising: a first magnetic induction element, a magnet set, a coil, and at least a second magnetic induction element.

The first magnetic induction element has a first end, a second end, a first side, a second side, a third side and a fourth side, wherein the first side and the second side are opposite to each other, while the third side and the fourth side are opposite to each other.

The magnet set comprises a first magnet, a second magnet, a third magnet, and a fourth magnet. The first magnet has an S pole and an N pole. The N pole of the first magnet presses against the first side of the first magnet induction element. The second magnet has an S pole and an N pole. The N pole of the second magnet presses against the second side of the first magnet induction element. The third magnet has an S pole and an N pole. The S pole of the third magnet presses against the third side of the first magnet induction element. The fourth magnet has an S pole and an N pole. The S pole of the fourth magnet presses against the fourth side of the first magnet induction element.

The coil surrounds the first magnetic induction element, the third magnet and the fourth magnet, and maintains a distance from the first end and the second end of the first magnetic induction element, and from the N pole of the third magnet and the N pole of the fourth magnet.

The second magnetic induction element is disposed at the coil, located above or below the first magnet and maintains a distance from the first magnet.

According to a preferred embodiment, the side of the coil corresponding to the first magnet is defined as a first side part. The first side part of the coil comprises an upper part and a lower part. The second magnetic induction element is disposed at the upper part or the lower part of the first side part of the coil. The two ends of the first magnet along the width are the S pole and the N pole. The two sides along the length of the first magnet are defined as the first side and the second side. The two ends along the length of the second magnetic induction element are defined as a first end and a second end. The two sides along the width of the second magnetic induction element are defined as a first side and a second side. The first end of the second magnetic induction element is disposed at the upper part or the lower part of the first side part of the coil. The length of the second magnetic induction element is the same as the width of the first magnet. The width of the second magnetic induction element is less than the length of the first magnet. The first end of the second magnetic induction element is disposed at the center of the upper part or the center of the lower part of the first side part of the coil, wherein the length of the second magnetic induction element is the same as the length of the first magnet. The width of the second magnetic induction element is the same as the width of the first magnet.

According to a preferred embodiment, the resettable dual diamagnetic linear resonant actuator further comprises at least a third magnetic induction element, disposed at the coil, located above or the below the second magnet and maintains a distance from the second magnet, wherein the side of the coil corresponding to the second magnet is defined as a second side part. The second side part of the coil comprises an upper part and a lower part. The third magnetic induction element is disposed at the upper part or the lower part of the second side part of the coil, wherein the two ends of the second magnet along the width are the S pole and the N pole. The two sides along the length of the second magnet are defined as the first side and the second side. The two ends along the length of the third magnetic induction element are defined as a first end and a second end. The two sides along the width of the third magnetic induction element are defined as a first side and a second side. The first end of the third magnetic induction element is disposed at the upper part or the lower part of the second side part of the coil. The length of the third magnetic induction element is the same as the width of the second magnet. The width of the third magnetic induction element is less than the length of the second magnet, wherein the first end of the third magnetic induction element is disposed at the center of the upper part or the center of the lower part of the second side part of the coil, wherein the length of the third magnetic induction element is the same as the length of the second magnet. The width of the third magnetic induction element is the same as the width of the second magnet.

According to a preferred embodiment, the resettable dual diamagnetic linear resonant actuator further comprises two second magnetic induction elements and further comprises two third magnetic induction elements. The two second magnetic induction elements are disposed at the coil, located respectively above and below the first magnet and maintain respectively a distance from the first magnet. The two third magnetic induction elements are disposed at the coil, located respectively above and below the second magnet, and maintain respectively a distance from the second magnet, wherein the side of the coil corresponding to the first magnet is defined as a first side part. The first side part of the coil comprises an upper part and a lower part. The side of the coil corresponding to the second magnet is defined as a second side part. The second side part of the coil comprises an upper part and a lower part. The two second magnetic induction elements are disposed respectively at the upper part and the lower part of the first side part of the coil. The two third magnetic induction elements are disposed respectively at the upper part and the lower part of the second side part of the coil. The two ends of the first magnet along the width are the S pole and the N pole. The two sides along the length of the first magnet are defined as the first side and the second side. The two ends of the second magnet along the width are the S pole and the N pole. The two sides along the length of the second magnet are defined as the first side and the second side. The two ends along the length of the two second magnetic induction elements are defined as a first end and a second end. The two sides along the width of the two second magnetic induction elements are defined as a first side and a second side. The first ends of the two second magnetic induction elements are disposed respectively at the upper part and the lower part of the first side part of the coil. The two ends along the length of the two third magnetic induction elements are defined as a first end and a second end. The two sides along the width of the two third magnetic induction elements are defined as a first side and a second side. The first ends of the two third magnetic induction elements are disposed respectively at the upper part and the lower part of the second side part of the coil. The length of the two second magnetic induction elements is the same as the width of the first magnet. The width of the two second magnetic induction elements is less than the length of the first magnet. The length of the two third magnetic induction elements is the same as the width of the second magnet. The width of the two third magnetic induction elements is less than the length of the second magnet, wherein the first ends of the two second magnetic induction elements are disposed respectively at the center of the upper part and the center of the lower part of the first side part of the coil, and the first ends of the two third magnetic induction elements are disposed respectively at the center of the upper part and the center of the lower part of the second side part of the coil, wherein the length of the two second magnetic induction elements is the same as the length of the first magnet, and the width of the two second magnetic induction elements is the same as the width of the first magnet; the length of the two third magnetic induction elements is the same as the length of the second magnet, and the width of the two third magnetic induction elements is the same as the width of the second magnet.

According to a preferred embodiment, the resettable dual diamagnetic linear resonant actuator further comprises: an inner sliding track set and an outer sliding track set. The inner sliding track set comprises at least two bases and a plurality of roller balls. The two bases are disposed respectively at the first magnet and the second magnet, and respectively form a plurality of inner side tracks. The roller balls are movably disposed at the plurality of inner side tracks. The outer sliding track set comprises two outer side tracks. The coil is fixed to the two outer side tracks, and the roller balls respectively contact the two outer side tracks.

The advantages of the present invention lies in that, after the electricity is cut off from the coil, the movable part formed by the first magnetic induction element, the magnet set, the second magnetic induction element and/or the third magnetic induction element is able to return to original position by the pushing force of the magnetic restoration force.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of the resettable dual diamagnetic linear resonant actuator in accordance with an exemplary embodiment;

FIG. 2 shows a dissected view of the resettable dual diamagnetic linear resonant actuator in accordance with an exemplary embodiment;

FIG. 3 shows a schematic view of the resettable dual diamagnetic linear resonant actuator with concentrated magnetic field density and guiding magnetic field towards coil in accordance with an exemplary embodiment;

FIG. 4 shows a schematic view of the resettable dual diamagnetic linear resonant actuator, including inner sliding track set and outer sliding track set in accordance with an exemplary embodiment;

FIG. 5 shows a schematic view of the resettable dual diamagnetic linear resonant actuator, including inner sliding track set in accordance with an exemplary embodiment;

FIG. 6 shows a dissected view of the resettable dual diamagnetic linear resonant actuator, including inner sliding track set in accordance with an exemplary embodiment;

FIG. 7 shows a schematic view of the resettable dual diamagnetic linear resonant actuator, including inner sliding track set and outer sliding track set, with concentrated magnetic field density and guiding magnetic field towards coil in accordance with an exemplary embodiment;

FIG. 8A shows a schematic view of the resettable dual diamagnetic linear resonant actuator with the movable part moving left with respect to the fixed part in accordance with an exemplary embodiment;

FIG. 8B shows a schematic view of the resettable dual diamagnetic linear resonant actuator, including inner sliding track set in accordance with an exemplary embodiment; and

FIG. 8C shows a schematic view of the resettable dual diamagnetic linear resonant actuator, after the electricity is cut off from the coil, the movable part returning to original position by the pushing force of the magnetic restoration force in accordance with an exemplary embodiment.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

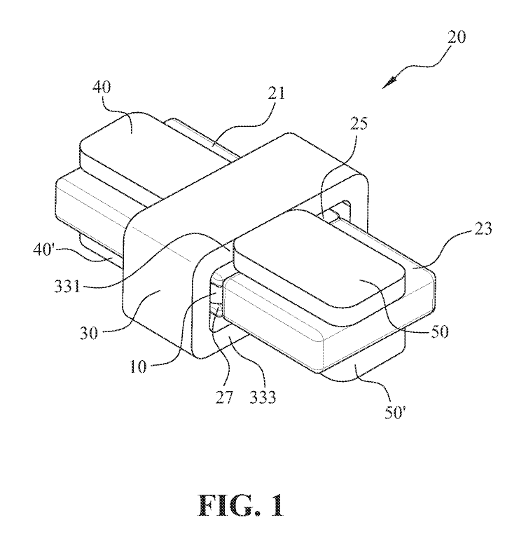

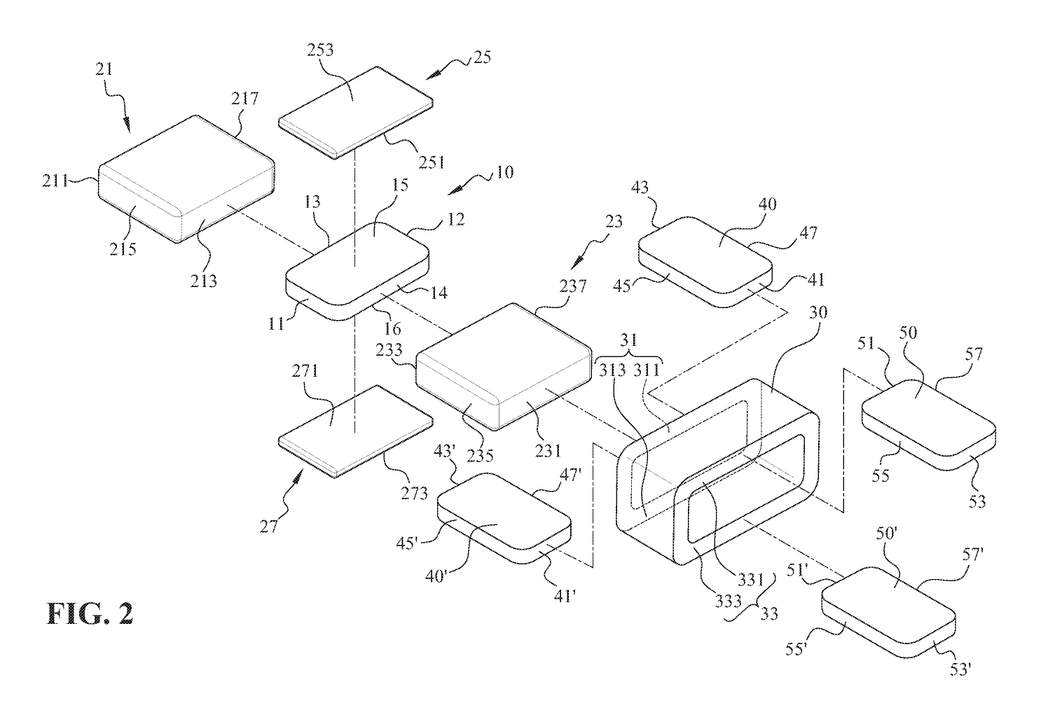

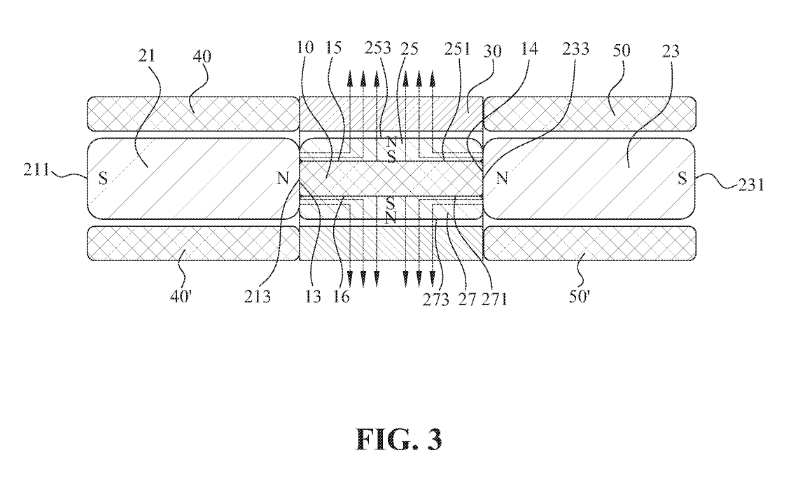

Refer to FIGS. 1-3. FIG. 1 shows a schematic view of the resettable dual diamagnetic linear resonant actuator in accordance with an exemplary embodiment; FIG. 2 shows a dissected view of the resettable dual diamagnetic linear resonant actuator in accordance with an exemplary embodiment and FIG. 3 shows a schematic view of the resettable dual diamagnetic linear resonant actuator with concentrated magnetic field density and guiding magnetic field towards coil in accordance with an exemplary embodiment. The present invention provides a resettable dual diamagnetic linear resonant actuator, comprising: a first magnetic induction element 10, a magnet set 20, a coil 30, two second magnetic induction elements 40, 40′, and two third magnetic induction elements 50, 50′.

The first magnetic induction element 10 has a first end 11, a second end 12, a first side 13, a second side 14, a third side 15 and a fourth side 16, wherein the first side 13 and the second side 14 are opposite to each other, while the third side 15 and the fourth side 16 are opposite to each other. In the present embodiment, the first magnetic induction element 10 is a cuboid. The distance between the first end 11 and the second end 12 is the length of the cuboid. The distance between the first side 13 and the second side 14 is the width of the cuboid. The distance between the third side 15 and the fourth side 16 is the height (i.e., thickness).

The magnet set 20 comprises a first magnet 21, a second magnet 23, a third magnet 25, and a fourth magnet 27. The first magnet 21 has an S pole 211 and an N pole 213. The N pole 213 of the first magnet 211 presses against the first side 13 of the first magnet induction element 10. The second magnet 23 has an S pole 231 and an N pole 233. The N pole 231 of the second magnet 23 presses against the second side 14 of the first magnet induction element 10. The third magnet 25 has an S pole 251 and an N pole 253. The S pole 251 of the third magnet 25 presses against the third side 15 of the first magnet induction element 10. The fourth magnet 27 has an S pole 271 and an N pole 273. The S pole 271 of the fourth magnet 27 presses against the fourth side 16 of the first magnet induction element 10. In the present embodiment, the thickness of the first magnetic induction element 10 is greater than the thickness of the third and the fourth magnets 25, 27. Preferably, the first and the second magnets 21, 23 are cuboids of the same size, and the third and the fourth magnets 25, 27 are cuboids of the same size. In other words, the first and the second magnets 21, 23 have the same length, width and height (i.e., thickness), and the third and the fourth magnets 25, 27 have the same length, width and height (i.e., thickness). Wherein, the two ends of the first magnet 21 along the width are the S pole 211 and the N pole 213. The two sides along the length of the first magnet 21 are defined as the first side and the second side 217. The two ends of the second magnet 23 along the width are the S pole 231 and the N pole 233. The two sides along the length of the second magnet 23 are defined as the first side 235 and the second side 237. Preferably, the thickness of the first magnet 21 and the second magnet 23 is the same as the combined thickness of the first magnetic induction element 10, the third magnet 25 and the fourth magnet 27. Preferably, the first, second, third and fourth magnets 21, 23, 25, 27 have the same length as the first magnetic induction element 10; the third and the fourth magnets 25, 27 have the same width as the first magnetic induction element 10; the center of the N pole 213, 233 of the first and the second magnets 21, 23 presses respectively against the first side 13 and the second side 14 of the first magnetic induction element 10; the part of the N pole 213, 233 of the first and the second magnets 21, 23 near the top and the bottom of the first and the second magnets 21, 23 presses against the two sides of the third and the fourth magnets 25, 27.

The coil 30 surrounds the first magnetic induction element 10, the third magnet 25 and the fourth magnet 27, and maintains a distance from the first end 11 and the second end 12 of the first magnetic induction element 10, and from the N pole 253 of the third magnet 25 and the N pole 273 of the fourth magnet 27. Wherein, the side of the coil 30 corresponding to the first magnet 21 is defined as a first side part 31. The first side part 31 of the coil 30 comprises an upper part 311 and a lower part 313; the side of the coil 30 corresponding to the second magnet 23 is defined as a second side part 33. The second side part 33 of the coil 30 comprises an upper part 331 and a lower part 333.

The two second magnetic induction elements 40, 40′ are disposed at the coil 30, located respectively above and below the first magnet 21 and maintain respectively a distance from the first magnet 21. Preferably, two second magnetic induction elements 40, 40′ are disposed respectively at the upper part 311 and the lower part 313 of the first side part 31 of the coil 30. Preferably, the two ends of the two second magnetic induction elements 40, 40′ along the length are defined as a first end 41, 41′ and a second end 43, 43′, respectively. The two sides of the two second magnetic induction elements 40, 40′ are defined as a first side 45, 45′ and a second side 47, 47′, respectively. The first ends 41, 41′ of the two second magnetic induction elements 40, 40′ are disposed respectively at the upper part 311 and the lower part 313 of the first side part 31 of the coil 30. Wherein, the length of the two second magnetic induction elements 40, 40′ is the same as the width of the first magnet 21, and the width of the two second magnetic induction elements 40, 40′ is less than the length of the first magnet 21. Preferably, the first ends 41, 41′ of the two second magnetic induction elements 40, 40′ are disposed respectively at the center of the upper part 311 and the center of the lower part 313 of the first side part 31 of the coil 30. In other embodiments, it is also allowable that the length of the two second magnetic induction elements 40, 40′ is the same as the width of the first magnet 21, and the width of the two second magnetic induction elements 40, 40′ is the same as the length of the first magnet 21. In other embodiments, the resettable dual diamagnetic linear resonant actuator may also comprise only one second magnetic induction element 40.

The two third magnetic induction elements 50, 50′ are disposed at the coil 30, located respectively above and below the second magnet 23, and maintain respectively a distance from the second magnet 23. Preferably, the two third magnetic induction elements 50, 50′ are disposed respectively at the upper part 331 and the lower part 333 of the second side part 33 of the coil 30. Preferably, the two ends of the two third magnetic induction elements 50, 50′ along the length are defined as a first end 51, 51′ and a second end 53, 53′, respectively. The two sides of the two third magnetic induction elements 50, 50′ are defined as a first side 55, 55′ and a second side 57, 57′, respectively. The first ends 51, 51′ of the two third magnetic induction elements 50, 50′ are disposed respectively at the upper part 331 and the lower part 333 of the second side part 33 of the coil 30. Wherein, the length of the two third magnetic induction elements 50, 50′ is the same as the width of the second magnet 23, and the width of the two third magnetic induction elements 50, 50′ is less than the length of the second magnet 23. Preferably, the first ends 51, 51′ of the two third magnetic induction elements 50, 50′ are disposed respectively at the center of the upper part 331 and the center of the lower part 333 of the second side part 33 of the coil 30. Wherein, the two second magnetic induction elements 40, 40′ and the two third magnetic induction elements 50, 50′ are cuboids of the same size. In other words, the two second magnetic induction elements 40, 40′ and the two third magnetic induction elements 50, 50′ have the same length, width and height (i.e., thickness). In other embodiments, it is also allowable that the length of the two third magnetic induction elements 50, 50′ is the same as the width of the second magnet 23, and the width of the two third magnetic induction elements 50, 50′ is the same as the length of the second magnet 23. In other embodiments, the resettable dual diamagnetic linear resonant actuator may also comprise only one third magnetic induction element 50.

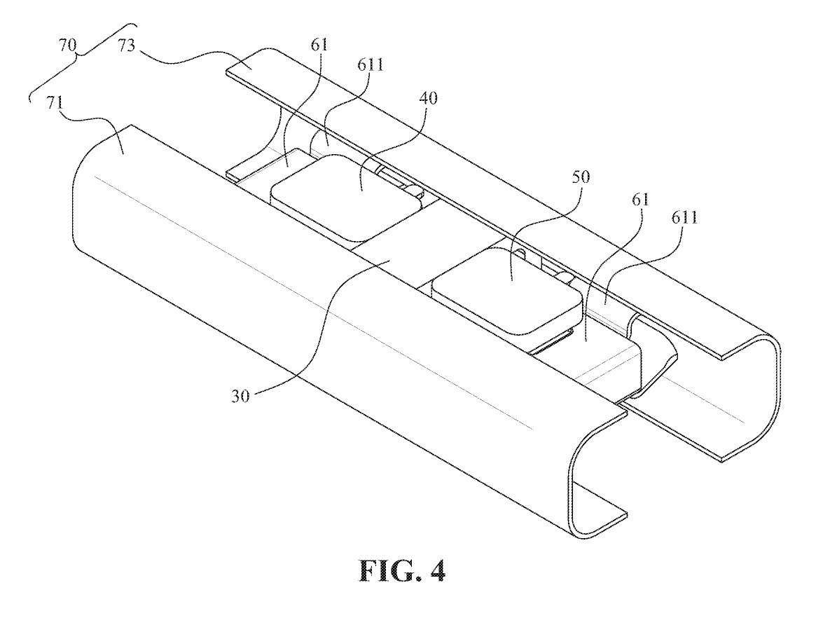

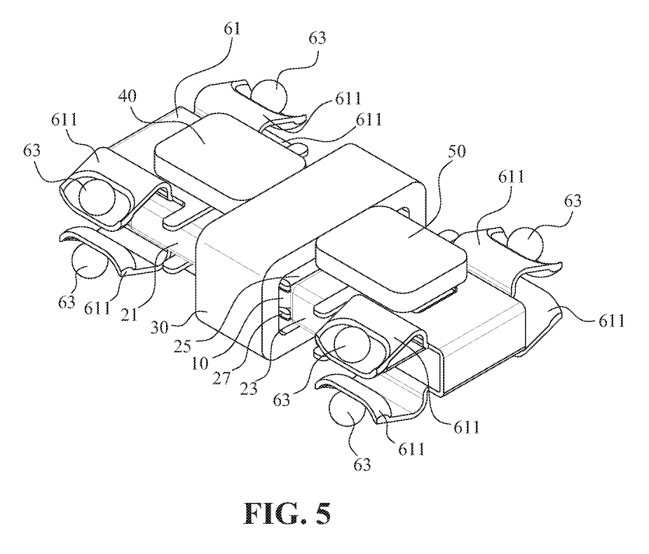

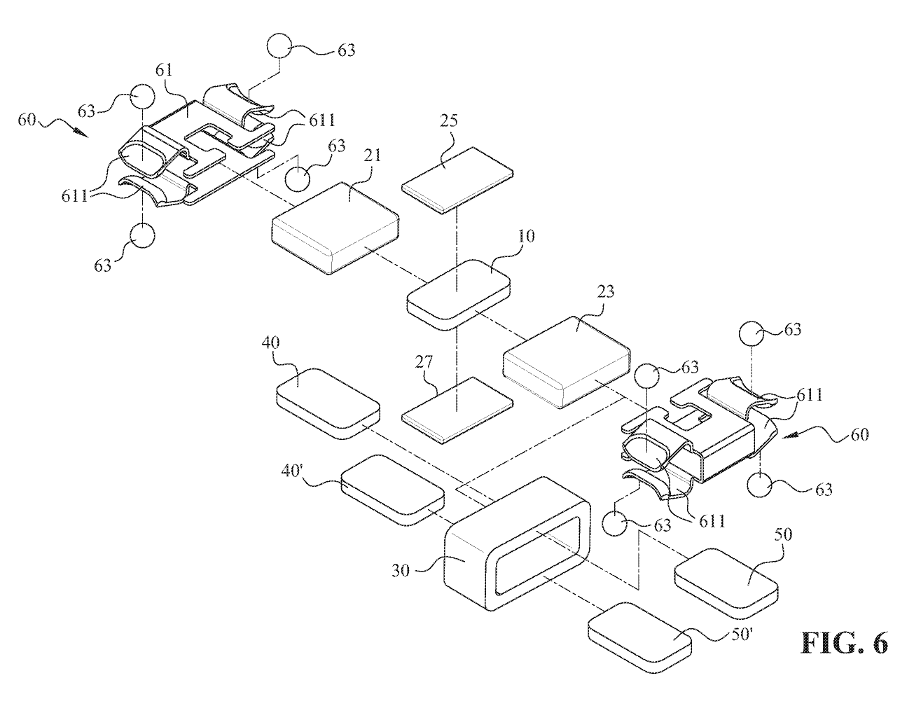

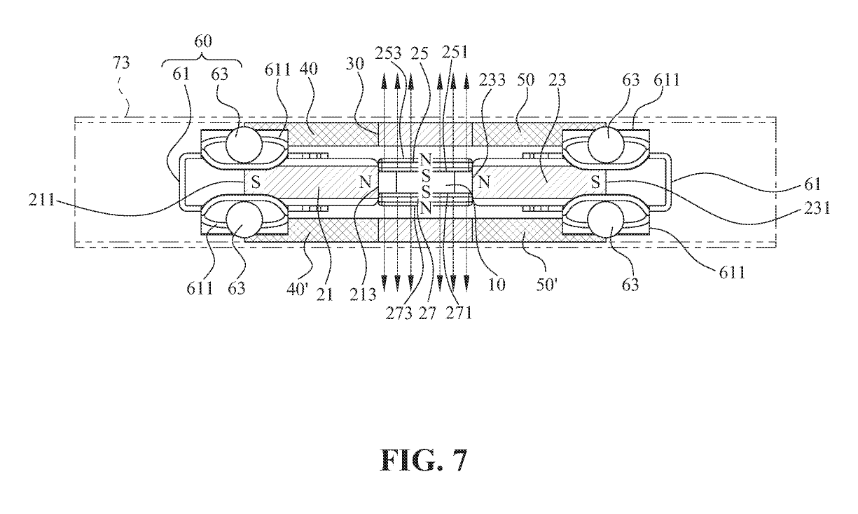

Refer to FIGS. 4-7. FIG. 4 shows a schematic view of the resettable dual diamagnetic linear resonant actuator, including inner sliding track set and outer sliding track set in accordance with an exemplary embodiment; FIG. 5 shows a schematic view of the resettable dual diamagnetic linear resonant actuator, including inner sliding track set in accordance with an exemplary embodiment; FIG. 6 shows a dissected view of the resettable dual diamagnetic linear resonant actuator, including inner sliding track set in accordance with an exemplary embodiment; and FIG. 7 shows a schematic view of the resettable dual diamagnetic linear resonant actuator, including inner sliding track set and outer sliding track set, with concentrated magnetic field density and guiding magnetic field towards coil in accordance with an exemplary embodiment. The resettable dual diamagnetic linear resonant actuator further comprises: an inner sliding track set 60 and an outer sliding track set 70. The inner sliding track set 60 comprises at least two bases 61 and a plurality of roller balls 63. The two bases 61 are disposed respectively at the first magnet 21 and the second magnet 23, and respectively form a plurality of inner side tracks 611. The roller balls 63 are movably disposed at the plurality of inner side tracks 611. The outer sliding track set 70 comprises two outer side tracks 71, 73. The coil 30 is fixed to the two outer side tracks 71, 73, and the roller balls 63 respectively contact the two outer side tracks 71, 73. In the present embodiment, the inner sliding track set 60 comprises eight roller balls 63, and each base 61 forms two inner side tracks 611 on two sides respectively. The two inner side tracks 611 are disposed corresponding to each other in upper and lower positions respectively. As such, the magnetic induction element 10, the magnet set 20 and the inner sliding track set 60 form a movable part. The coil 30, the second magnetic induction elements 40, 40′, the third magnetic induction elements 50, 50′, and the outer sliding track set 70 form a fixed part. Four roller balls 63 located at one side of the movable part contact one of the outer side track 71, and the other four roller balls 63 located at the other side of the movable part contact the other outer side track 73.

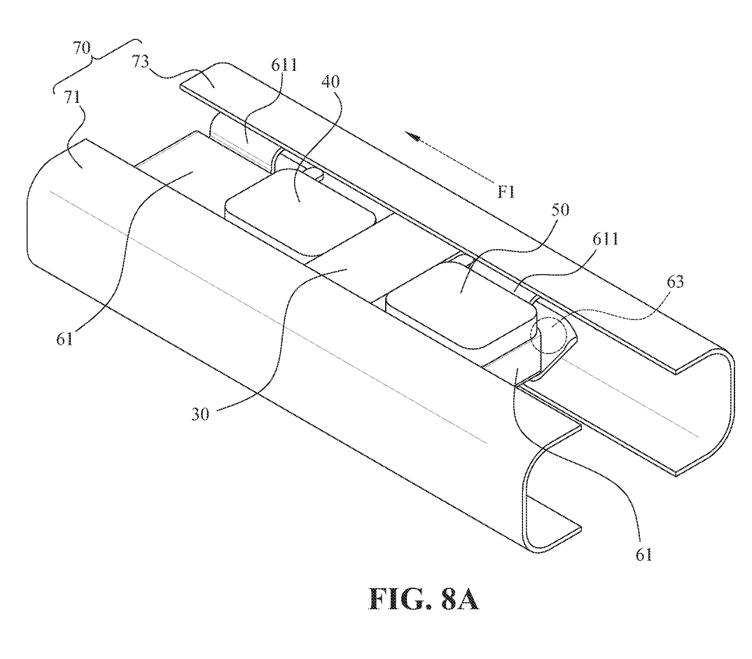

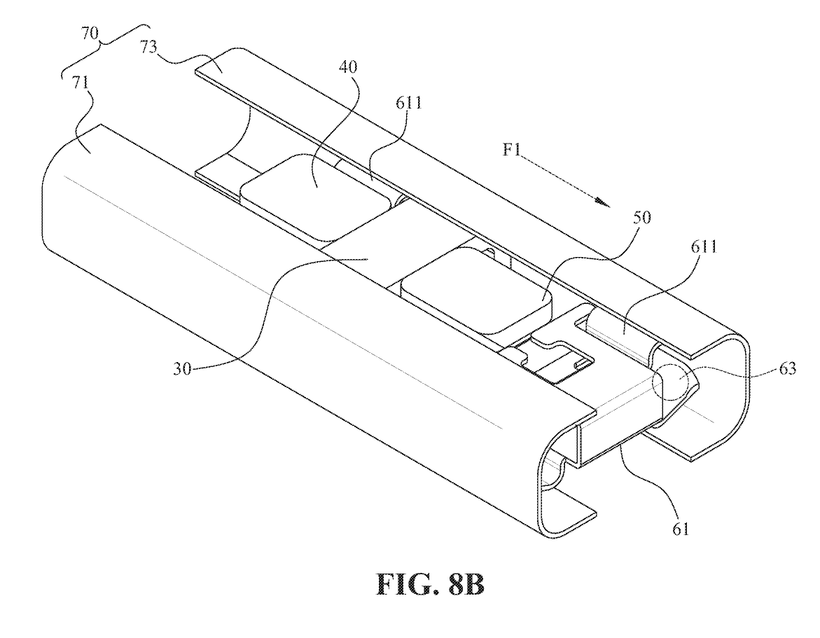

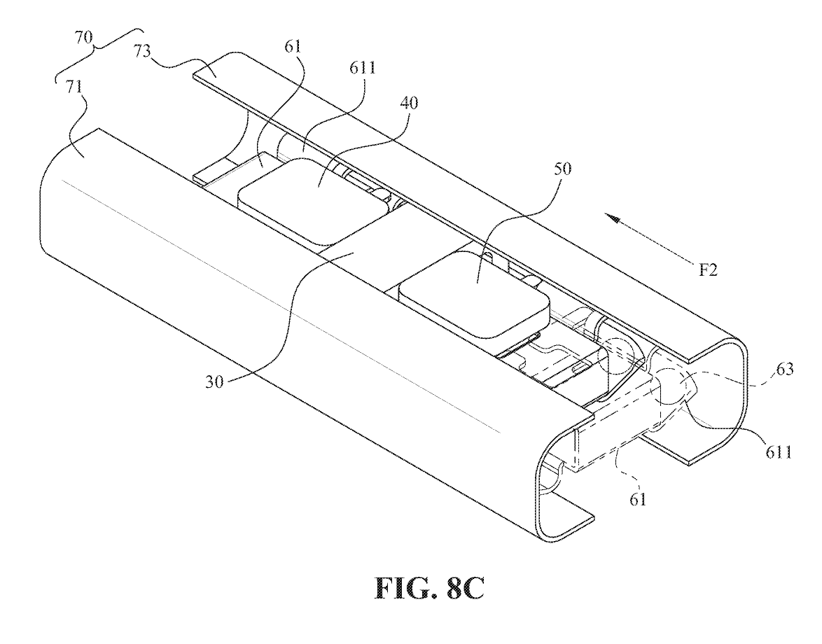

Refer to FIG. 3. FIG. 7. FIG. 8A and FIG. 8B. FIG. 3 shows a schematic view of the resettable dual diamagnetic linear resonant actuator with concentrated magnetic field density and guiding magnetic field towards coil in accordance with an exemplary embodiment; FIG. 7 shows a schematic view of the resettable dual diamagnetic linear resonant actuator, including inner sliding track set and outer sliding track set, with concentrated magnetic field density and guiding magnetic field towards coil in accordance with an exemplary embodiment; FIG. 8A shows a schematic view of the resettable dual diamagnetic linear resonant actuator with the movable part moving left with respect to the fixed part in accordance with an exemplary embodiment; and FIG. 8B shows a schematic view of the resettable dual diamagnetic linear resonant actuator, including inner sliding track set in accordance with an exemplary embodiment. When the electricity runs through coil 30 continuously in alternating directions, the current through the coil 30 interacts with the magnetic field coming out of the magnet set 20 to generate Lorentz force F1. As such, the movable part can move to left and right with respect to the fixed part in a simple harmonic motion manner, as shown in FIGS. 8A and 8B. When the frequency of the simple harmonic motion reaches the resonance state of the present invention, the present invention will reach the maximum resonant state.

Refer to FIG. 8C. FIG. 8C shows a schematic view of the resettable dual diamagnetic linear resonant actuator, after the electricity is cut off from the coil, the movable part returning to original position by the pushing force of the magnetic restoration force in accordance with an exemplary embodiment. Wherein, when the movable part executes simple harmonic motion with respect to the fixed part, a magnetic restoration force F2 is generated between the first and the second magnets 21, 23, and the second and the third magnetic induction elements 40, 40′, 50, 50′. In general, the Lorentz force F1 is greater than the magnetic restoration force F2. Hence, when the electricity passes through the coil 30 continuously in alternating directions, the movable part is affected by the Lorentz force F1 to execute simple harmonic motion with respect to the fixed part. When the electricity is cut off from the coil 30, the Lorentz force F1 disappears immediately, and the movable part is no longer affected by the Lorentz force F1. As such, the magnetic restoration force F2 can immediately push the movable part to the original position so that the coil 30 once again surrounds the first magnetic induction element 10, the third magnet 25 and the fourth magnet 27.

In the resettable dual diamagnetic linear resonant actuator of the present invention, the N poles 213, 233 of the first and the second magnets 21, 23 press respectively against the first side 13 and the second side 14 of the first magnetic induction element 10, the S poles 251, 271 of the third and fourth magnets 25, 27 press respectively against the third side 15 and the fourth side 16 of the first magnetic induction element 10, the coil 30 surrounds the first magnetic induction element 10, the third magnet 25 and the fourth magnet 27, and maintains a distance from the first end 11, the second end 12 of the first magnetic induction element 10 and from the N poles 253, 273 of the third and the fourth magnets 25, 27. As such, the first and the second magnets 21, 23 will compress the lines of magnetic force, and the third and fourth magnets 25, 27 will strengthen the magnetic force and guide the lines of magnetic force towards the coil 30 to achieve concentrating the density of the magnetic field and guiding the magnetic field towards the coil 30 to avoid divergence of lines of magnetic force and improve utilization efficiency of the magnetic field.

Moreover, in the present embodiment, because the two second magnetic induction elements 40, 40′ and the two third magnetic induction elements 50, 50′ are disposed at the coil 30, with the two second magnetic induction elements 40, 40′ located respectively above and below the first magnet 21 and maintaining a distance from the first magnet 21, and the two third magnetic induction elements 50, 50′ located respectively above and below the second magnet 23 and maintaining a distance from the second magnet 23. As such, the present invention can provide stable magnetic restoration force so that the movable part will stably return to original position after the electricity is cut off from the coil 30.

Furthermore, the length of the two second magnetic induction elements 40, 40′ is the same as the width of the first magnet 21, and the width of the two second magnetic induction elements 40, 40′ is less than the length of the first magnet 21. The length of the two third magnetic induction elements 50, 50′ is the same as the width of the second magnet 23, and the width of the two third magnetic induction elements 50, 50′ is less than the length of the second magnet 23. As such, the present invention can provide outstanding magnetic restoration force F2 so that the movable part will stably return to original position after the electricity is cut off from the coil 30.

Also, the first ends 41, 41′ of the two second magnetic induction elements 40, 40′ are disposed respectively at the center of the upper part 311 and the center of the lower part 313 of the first side part 31 of the coil 30, the first ends 51, 51′ of the two third magnetic induction elements 50, 50′ are disposed respectively at the center of the upper part 331 and the center of the lower part 333 of the second side part 33 of the coil 30. As such, the present invention can provide balanced magnetic restoration force F2 so that the movable part will stably return to original position after the electricity is cut off from the coil 30.

It should be noted that the two second magnetic induction elements 40, 40′ have the same length and width as the length and width of the first magnet 21, and the two third magnetic induction elements 50, 50′ have the same length and width as the length and width of the second magnet 23. As such, the present invention can provide balanced and outstanding magnetic restoration force F2 so that the movable part will stably return to original position after the electricity is cut off from the coil 30, which shows the most prominent result of all the embodiments.

In fact, the present invention only needs to dispose a second magnetic induction element 40 at the coil 30 to provide the magnetic restoration force, but the effect would be slightly less prominent than the above embodiment. If a third magnetic induction element 50 is added to the coil 30 in addition to the second magnetic induction element 40, the magnetic restoration force is more balanced, but the effect is still less than the previous embodiment.

It will be apparent to those skilled in the art a various modifications and variations can be made to the disclosed embodiments. It is intended that the specification and examples be considered as exemplary only, with a true scope of the disclosure being indicated by the following claims and their equivalents.

What is claimed is:

1. A resettable dual diamagnetic linear resonance actuator, comprising:
a first magnetic induction element, having a first end, a second end, a first side, a second side, a third side and a fourth side, wherein the first side and the second side being opposite to each other, while the third side and the fourth side being opposite to each other;
a magnet set, fluffier comprising a first magnet, a second magnet, a third magnet, and a fourth magnet; wherein the first magnet having an S pole and an N pole; the N pole of the first magnet pressing against the first side of the first magnet induction element; the second magnet having an S pole and an N pole; the N pole of the second magnet pressing against the second side of the first magnet induction element; the third magnet having an S pole and an N pole; the S pole of the third magnet pressing against the third side of the first magnet induction element; the fourth magnet having an S pole and an N pole; the S pole of the fourth magnet pressing against the fourth side of the first magnet induction element;
a coil, surrounding the first magnetic induction element, the third magnet and the fourth magnet, and maintaining a distance from the first end and the second end of the first magnetic induction element, and from the N pole of the third magnet and the N pole of the fourth magnet; and
at least a second magnetic induction element, disposed at the coil, located above or below the first magnet and maintaining a distance from the first magnet.

2. The resettable dual diamagnetic linear resonance actuator as claimed in claim 1, wherein the side of the coil corresponding to the first magnet is defined as a first side part, the first side part of the coil comprises an upper part and a lower part, and the second magnetic induction element is disposed at the upper part or the lower part of the first side part of the coil.

3. The resettable dual diamagnetic linear resonance actuator as claimed in claim 2, wherein the two ends of the first magnet along the width are the S pole and the N pole, the two sides along the length of the first magnet are defined as the first side and the second side, the two ends of the second magnetic induction element along the width are the S pole and the N pole, the two sides along the length of the second magnetic induction element are defined as the first side and the second side, the first end of the second magnetic induction element is disposed at the upper part or the lower part of the first side part of the coil, the length of the second magnetic induction element is the same as the width of the first magnet, and the width of the second magnetic induction element is less than the length of the first magnet.

4. The resettable dual diamagnetic linear resonance actuator as claimed in claim 3, wherein the first end of the second magnetic induction element is disposed at the center of the upper part or the center of the lower part of the first side part of the coil.

5. The resettable dual diamagnetic linear resonance actuator as claimed in claim 2, wherein the length of the second magnetic induction element is the same as the length of the first magnet, and the width of the second magnetic induction element is the same as the width of the first magnet.

6. The resettable dual diamagnetic linear resonance actuator as claimed in claim 1, further comprising at least a third magnetic induction element, disposed at the coil, located above or below the second magnet and maintaining a distance from the second magnet.

7. The resettable dual diamagnetic linear resonance actuator as claimed in claim 6, wherein the side of the coil corresponding to the second magnet is defined as a second side part, the second side part of the coil comprises an upper part and a lower part, and the third magnetic induction element is disposed at the upper part or the lower part of the second side part of the coil.

8. The resettable dual diamagnetic linear resonance actuator as claimed in claim 7, wherein the two ends of the second magnet along the width are the S pole and the N pole, the two sides along the length of the second magnet are defined as the first side and the second side, the two ends of the third magnetic induction element along the width are the S pole and the N pole, the two sides along the length of the third magnetic induction element are defined as the first side and the second side, the first end of the third magnetic induction element is disposed at the upper part or the lower part of the second side part of the coil, the length of the third magnetic induction element is the same as the width of the second magnet, and the width of the third magnetic induction element is less than the length of the second magnet.

9. The resettable dual diamagnetic linear resonance actuator as claimed in claim 8, wherein the first end of the third magnetic induction element is disposed at the center of the upper part or the center of the lower part of the second side part of the coil.

10. The resettable dual diamagnetic linear resonance actuator as claimed in claim 7, wherein the length of the third magnetic induction element is the same as the length of the second magnet, and the width of the third magnetic induction element is the same as the width of the second magnet.

11. The resettable dual diamagnetic linear resonance actuator as claimed in claim 1, further comprising two second magnetic induction elements and two third magnetic induction elements, the two second magnetic induction elements being disposed at the coil, located above or below the first magnet and maintaining a distance from the first magnet, and the two third magnetic induction elements being disposed at the coil, located above or below the second magnet and maintaining a distance from the second magnet.

12. The resettable dual diamagnetic linear resonance actuator as claimed in claim 11, wherein the side of the coil corresponding to the first magnet is defined as a first side part, the first side part of the coil comprises an upper part and a lower part, and the second magnetic induction element is disposed at the upper part or the lower part of the first side part of the coil; the side of the coil corresponding to the second magnet is defined as a second side part, the second side part of the coil comprises an upper part and a lower part; and the third magnetic induction element is disposed at the upper part or the lower part of the second side part of the coil.

13. The resettable dual diamagnetic linear resonance actuator as claimed in claim 12, wherein the two ends of the first magnet along the width are the S pole and the N pole, the two sides along the length of the first magnet are defined as the first side and the second side, the two ends of the second magnet along the width are the S pole and the N pole, the two sides along the length of the second magnet are defined as the first side and the second side, the two ends of the two second magnetic induction elements along the width are the S pole and the N pole, the two sides along the length of the two second magnetic induction element are defined as the first side and the second side, the first ends of the two second magnetic induction elements are disposed respectively at the upper part and the lower part of the first side part of the coil, the two ends of the two third magnetic induction elements along the width are the S pole and the N pole, the two sides along the length of the two third magnetic induction elements are defined as the first side and the second side, the first ends of the two third magnetic induction elements are disposed respectively at the upper part and the lower part of the second side part of the coil, wherein the length of the two second magnetic induction elements is the same as the width of the first magnet, and the width of the two second magnetic induction elements is less than the length of the first magnet, the length of the two third magnetic induction elements is the same as the width of the second magnet, and the width of the two third magnetic induction elements is less than the length of the second magnet.

14. The resettable dual diamagnetic linear resonance actuator as claimed in claim 13, wherein the first ends of the two second magnetic induction elements are disposed respectively at the center the upper part or the center of the lower part of the first side part of the coil; the first ends of the two third magnetic induction elements are disposed respectively at the center of the upper part or the center of the lower part of the second side part of the coil.

15. The resettable dual diamagnetic linear resonance actuator as claimed in claim 12, wherein the length of the two second magnetic induction elements is the same as the length of the first magnet, and the width of the two second magnetic induction elements is the same as the width of the first magnet; the length of the two third magnetic induction elements is the same as the length of the second magnet, and the width of the two third magnetic induction elements is the same as the width of the second magnet.

16. The resettable dual diamagnetic linear resonance actuator as claimed in claim 1, further comprising: an inner sliding track set and an outer sliding track set; wherein the inner sliding track set comprising at least two bases and a plurality of roller balls; the two bases being disposed respectively at the first magnet and the second magnet, and respectively forming a plurality of inner side tracks; the roller balls being movably disposed at the plurality of inner side tracks; the outer sliding track set comprising two outer side tracks; the coil being fixed to the two outer side tracks, and the roller balls respectively contacting the two outer side tracks.
